(19) United States
(12) Patent Application Publication
(10) Pub. No.: US 2025/0029354 A1
(43) Pub. Date: Jan. 23, 2025

(54) IMAGE SEGMENTATION METHOD AND IMAGE PROCESSING SYSTEM

(71) Applicant: HTC Corporation, Taoyuan City (TW)

(72) Inventors: Sheng-Hung FAN, Taoyuan City (TW); Yu-Shao PENG, Taoyuan City (TW)

(21) Appl. No.: 18/777,575

(22) Filed: Jul. 19, 2024

Related U.S. Application Data
(60) Provisional application No. 63/514,791, filed on Jul. 20, 2023.

(51) Int. Cl. G06V 10/26; G06T 11/20; G06V 10/25; G06V 10/44; G06V 10/74; G06V 10/774; G06V 10/96

(52) U.S. Cl. CPC G06V 10/267; G06T 11/206; G06V 10/25; G06V 10/443; G06V 10/74; G06V 10/774; G06V 10/96

(57) ABSTRACT

An image segmentation method includes following steps. An input image is provided to a prompter model for generating a first prompt indictor according to a task type of the prompter model. A prompt enhancement procedure, with reference to the task type of the prompter model, is performed to the first prompt indictor for generating a second prompt indictor. The prompt enhancement procedure includes converting a location, a size or a prompt type of the first prompt indictor into the second prompt indictor with reference to the task type. The input image and the second prompt indictor are provided to a segmentation foundation model for generating an output segmentation mask on the input image according to the second prompt indictor.

### RELATED APPLICATIONS

This application claims the priority benefit of U.S. Provisional Application Ser. No. 63/514,791, filed Jul. 20, 2023, which is herein incorporated by reference.

### BACKGROUND

### Field of Invention

The disclosure relates to an image segmentation method and system. More particularly, the disclosure relates to an image segmentation method and system integrated with a segmentation foundation model.

### Description of Related Art

Artificial Intelligence (AI) has experienced rapid development in recent years, and various fields such as industry, commerce, and healthcare have begun to extensively adopt AI technologies to assist their operations. However, most enterprises lack the corresponding capabilities to construct AI models suitable for their own. Therefore, most enterprises tend to use automated machine learning platforms or seek collaborations to construct their AI models. Automated machine learning platforms enable enterprise users with basic AI knowledge to build AI models specific to their enterprises through automated training methods. These platforms provide a variety of models for users to choose from, allowing them to select models with corresponding capabilities according to their needs and train the chosen models using their collected datasets.

Although automated machine learning platforms offer various models for users to choose from, the most critical part, training data, still needs to be prepared by the users themselves. Having a large amount of well-labeled data is a significant burden for users, as it involves setting labeling rules, preparing unlabeled datasets, and having professionals (such as production line technicians, quality control personnel or radiologists) label the data according to established rules. If the task involves image segmentation, it becomes even more time-consuming. Image segmentation tasks require labeling every pixel, which takes a lot of time even for experienced annotators. Generally, training a machine learning model requires a large amount of labeled data, substantial time, and equipment for training.

As described above, the existing process for training an image segmentation model involves the following steps: collecting data, labelling data, choosing a suitable model, loading labeled datasets, training the model and obtaining the trained model. For example, the model can be trained to locate a dog within input images based on labelled image data about dog. If the trained model needs enhancement (e.g., adding a segmentation function about cat), some training steps are required to repeat to re-train the model, and these re-training steps consume a lot of time, manpower, and computational resource.

### SUMMARY

An embodiment of the disclosure provides an image segmentation method, which includes following steps. An input image is provided to a prompter model for generating a first prompt indictor according to a task type of the prompter model. A prompt enhancement procedure, with reference to the task type of the prompter model, is performed to the first prompt indictor for generating a second prompt indictor. The prompt enhancement procedure includes converting a location, a size or a prompt type of the first prompt indictor into the second prompt indictor with reference to the task type. The input image and the second prompt indictor are provided to a segmentation foundation model for generating an output segmentation mask on the input image according to the second prompt indictor.

Another embodiment of the disclosure provides an image processing system, which includes a storage unit and a processing unit. The storage unit is configured to store computer-executable instructions. The processing unit is coupled with the storage unit. The processing unit is configured to execute the computer-executable instructions. The processing unit is configured to provide an input image to a prompter model for generating a first prompt indictor according to a task type of the prompter model. The processing unit is configured to perform a prompt enhancement procedure, with reference to the task type of the prompter model, to the first prompt indictor for generating a second prompt indictor. The prompt enhancement procedure includes converting a location, a size or a prompt type of the first prompt indictor into the second prompt indictor with reference to the task type. The processing unit is configured to provide the input image and the second prompt indictor to a segmentation foundation model for generating an output segmentation mask on the input image according to the second prompt indictor.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram illustrating an image processing system in some embodiments of the disclosure.

FIG. 2 is a flowchart diagram illustrating the image segmentation method according to some embodiments of this disclosure.

FIG. 3 is a schematic diagram illustrating the input image, a first prompt indicator, a second prompt indicator, an output segmentation mask and an output image generated during the image segmentation method in some embodiments.

FIG. 4 is a flowchart diagram illustrating a training method 400 of the prompter model.

FIG. 5 is a schematic diagram illustrating a demonstrational case about the input image, the first prompt indicator and the second prompt indicator when the task type of the prompter model is the object detection type in some embodiments.

FIG. 6 is another schematic diagram illustrating a demonstrational case about the input image, the first prompt indicator and the second prompt indicator when the task type of the prompter model is the image segmentation type in some embodiments.

FIG. 7 is another schematic diagram illustrating a demonstrational case about the input image, the first prompt indicator and the second prompt indicator when the task type of the prompter model is the classification type in some embodiments.

FIG. 8A and FIG. 8B are schematic diagram illustrating different output segmentation masks generated by the segmentation foundation model based on different prompt indictors according to some embodiments.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

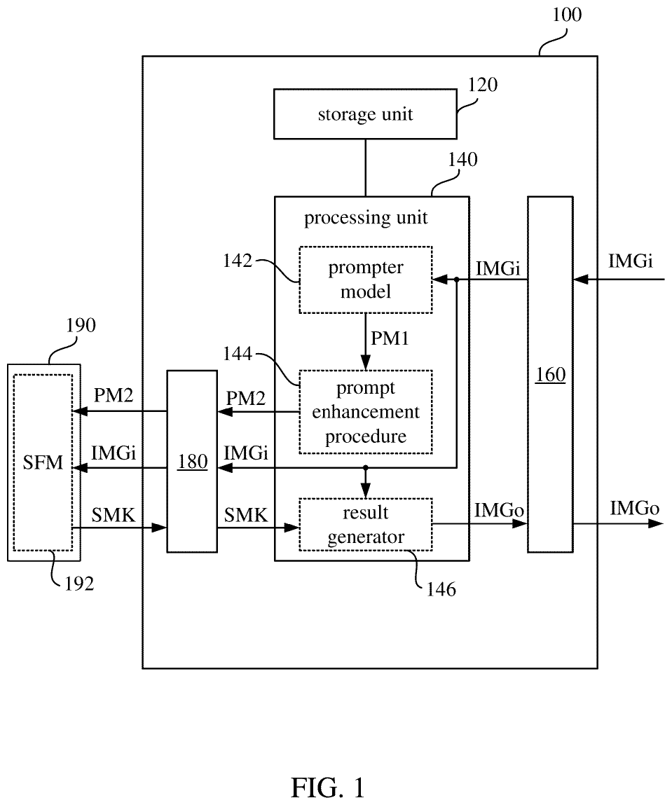

Reference is made to FIG. 1, which is a block diagram illustrating an image processing system 100 in some embodiments of the disclosure. In some embodiments, the image processing system 100 is able to perform a specific image segmentation task on an input image IMGi. For example, the image processing system 100 can be utilized to mark a potential tumor location from a Magnetic Resonance Imaging (MRI) scanning image, to locate a vehicle plate from a traffic monitoring image, to mark a cat from a grass background, or to separate a foreground person from a background scenery. In some embodiments, the image processing system 100 performs aforesaid image segmentation task in cooperation with a segmentation foundation model (SFM) 192.

The segmentation foundation model 192 refers to a comprehensive deep learning framework designed to perform various image segmentation tasks. The segmentation foundation model 192 serves as a general-purpose tool in computer vision for dividing images into meaningful parts or segments. The segmentation foundation model 192 is typically based on advanced neural network architectures like Transformers, Convolutional Neural Networks (CNNs) or Fully Convolutional Networks (FCNs). The segmentation foundation model 192 is trained on large and diverse datasets, allowing them to generalize well across different types of images and segmentation tasks. In some embodiments, the segmentation foundation model 192 can be operated on an external server 190 outside the image processing system 100.

In some embodiments, segment anything model (SAM) is one example to implement the segmentation foundation model 192. The segment anything model is able to complete image segmentation tasks based on prompt-based instructions. The segment anything model supports some types of prompt indictors (e.g., positive points, negative points, bounding boxes or description texts). However, segment anything model has some limitations when applied to customized instance segmentation. Firstly, the segment anything model requires correct and suitable prompts to indicate an intention of target segmentation task. Secondly, the segment anything model requires additional specific training (relative to the target segmentation task) to achieve optimal segmentation results.

The image processing system 100 in this disclosure provides a manner to generate a suitable prompt based on an input image IMGi, and provide the suitable prompt to the segmentation foundation model 192. As shown in FIG. 1, the image processing system 100 in some embodiments includes a storage unit 120, a processing unit 140, an interface 160 and a communication circuit 180. The processing unit 140 is coupled with the storage unit 120, the interface 160 and the communication circuit 180. In some embodiments, the storage unit 120 can be implemented by a memory, a cache memory or a hard drive; the processing unit 140 can be implemented by a central processing unit (CPU), a graphic processing unit (GPU), a tensor processing unit (TPU) or an application-specific integrated circuit (ASIC); the interface 160 may include an input terminal (e.g., a connector, an image scanner or a camera) and an output terminal (e.g., a displayer, a connector or a projector); the communication circuit 180 can be implemented by a network adopter, a telecommunication circuit or a wireless communication circuit.

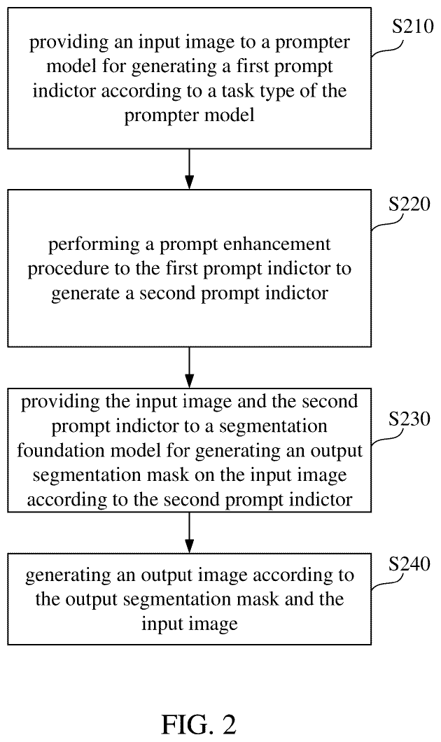

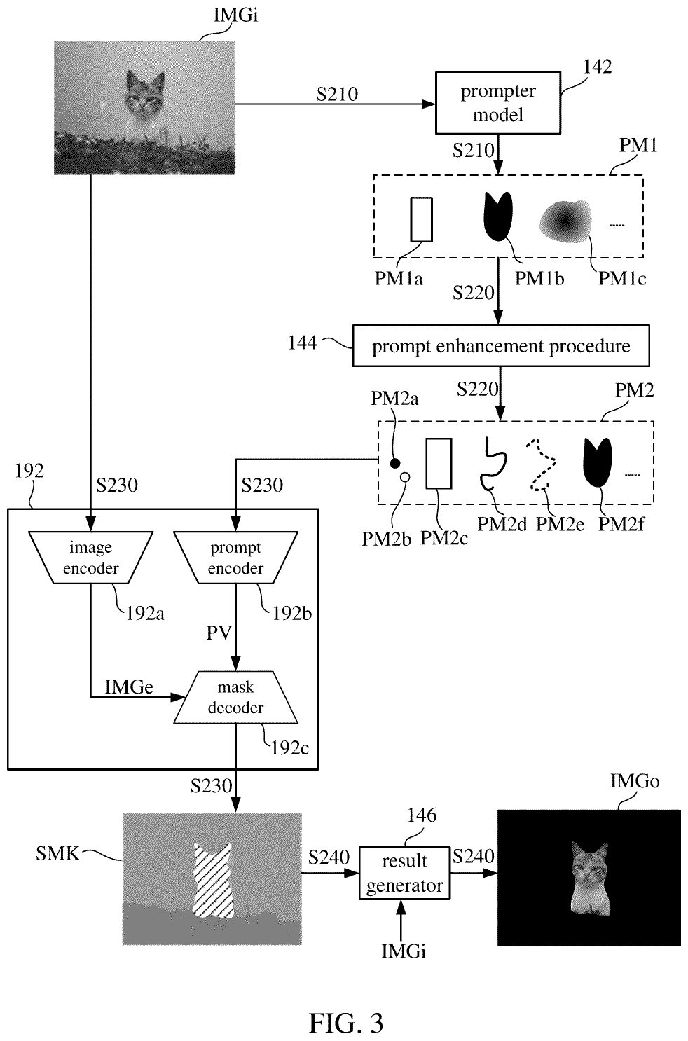

The storage unit 120 is configured to store computer-executable instructions. The computer-executable instructions can be executed by the processing unit 140 to perform an image segmentation method. Reference is further made to FIG. 2 and FIG. 3. FIG. 2 is a flowchart diagram illustrating the image segmentation method 200 according to some embodiments of this disclosure. FIG. 3 is a schematic diagram illustrating the input image IMGi, a first prompt indicator PM1, a second prompt indicator PM2, an output segmentation mask SMK and an output image IMGo generated during the image segmentation method 200 in some embodiments.

It is assumed that a new task target is to establish a new image segmentation model capable of segmenting cats from background. In order to achieve this new task target, the image processing system 100 utilizes a prompter model 142 and a prompt enhancement procedure 144 to generate suitable prompt indictor (e.g., a positive click on the cat, a negative click on background, a bounding box surrounding the cat, or a coarse segmentation mask on the cat) required by the segmentation foundation model 192. In this case, the segmentation foundation model 192 is able to generate a precise segmentation mask about the cat based on the suitable prompt indictor (generated by the prompter model 142 and the prompt enhancement procedure 144). Further details about the prompter model 142 and the prompt enhancement procedure 144 will be discussed in following paragraphs.

As shown in FIG. 1, FIG. 2 and FIG. 3, the image processing system 100 receives an input image IMGi through the interface 160. In step S210, the processing unit 140 provides the input image IMGi to the prompter model 142 for generating a first prompt indictor PM1 (e.g., a bounding box PM1a, a first segmentation mask PM1b or a heat map PM1c) according to a task type of the prompter model 142. In step S220, the processing unit 140 performs the prompt enhancement procedure 144, with reference to the task type of the prompter model 142, to the first prompt indictor PM1 to generate a second prompt indictor PM2 (e.g., a positive click PM2a, a negative click PM2b, a second bounding box PM2c, a positive trace PM2d, a negative trace PM2e or a second segmentation mask PM2f). In step S230, the image processing system 100 provides the input image IMGi and the second prompt indictor PM2 through the communication circuit 180 to the segmentation foundation model 192, such that the segmentation foundation model 192 will generates an output segmentation mask SMK on the input image IMGi according to the second prompt indictor PM2.

With cooperation of the segmentation foundation model 192, the image processing system 100 to able to obtain an output segmentation mask SMK. As shown in FIG. 1, FIG. 2 and FIG. 3, during step S240, the result generator 146 executed by the processing unit 140 is able to generate an output image IMGo according to the output segmentation mask SMK and the input image IMGi.

In some embodiments, the prompter model 142, the prompt enhancement procedure 144 and the result generator 146 can be implemented by software instructions executed by the processing unit 140. A task type of the prompter model 142 is selected among candidate task types such as an object detection type, an image segmentation type and a classification type. The prompter model 142 is trained to complete one of object detection, image segmentation or classification task based on a training dataset. The training dataset includes training images and label data corresponding to the training images.

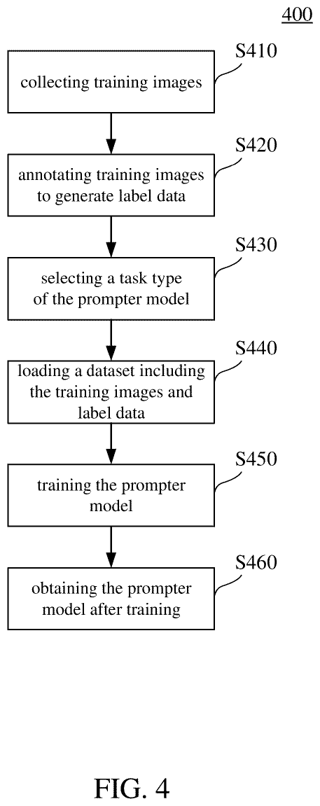

Reference is further made to FIG. 4, which is a flowchart diagram illustrating a training method 400 of the prompter model 142. As shown in FIG. 4, in the training method 400, step S410 is executed to collect training images (e.g., images involving cats). Step S420 is executed to annotate the training images for generating label data. Step S430 is executed to select a task type of the prompter model 142. For example, the task type of the prompter model 142 can be selected to be one of an object detection type (e.g., the prompter model 142 can be YOLO or Faster R-CNN model), an image segmentation type (e.g., the prompter model 142 can be Unet or Deeplab model) and a classification type (e.g., the prompter model 142 can be VGGNet or ResNet model). Step S440 is executed to load a dataset including the training images and label data in preparation to train. Step S450 is executed to train the prompter model 142. In some embodiments, step S450 includes: generating predictions of the training images by the prompter model 142, comparing the predictions with the label data, and adjusting parameters of the prompter model 142 based on aforesaid comparison result. Step S460 is executed to obtain the prompter model 142 after training.

In some embodiments, the prompter model 142 is trained with a smaller scale and a specific type of datasets, compared to a larger scale and diverse types of datasets utilized to train the segmentation foundation model 192. It is because that the prompter model 142 is not required to generate a precise location of image segmentation mask, because the output of the prompter model 142 is only utilized in generating prompts (as a hint/clue about segmentation intention to the segmentation foundation model 192), and a relatively heavier task of generating precise location of image segmentation mask is done by the segmentation foundation model 192 based on the prompt-based inputs. In addition, the prompter model 142 can be specific to achieve a certain purpose (e.g., finding cats) and the prompter model 142 is not required to handle various kinds of input images. Therefore, the prompter model 142 can be achieved by a relatively simple model with limited computation resource, and the prompter model 142 can be trained much faster based on the smaller scale and the specific type of datasets.

As discussed in FIG. 4, the prompter model 142 can be selected from various models with different task types including the object detection type, the image segmentation type or the classification type. In some embodiments, since the prompter model 142 is selected from different task types, the first prompt indictor PM1 generated by the prompter model 142 will be correspondingly in different formats with reference to the task type of the prompter model 142. As shown in FIG. 3, the first prompt indictor PM1 generated by the prompter model 142 can be one of the bounding box PM1a, the first segmentation mask PM1b or the heat map PM1c. In response to different type of the first prompt indictor PM1 (i.e., the bounding box PM1a, the first segmentation mask PM1b or the heat map PM1c), the prompt enhancement procedure 144 applying to the first prompt indictor PM1 will be differentiated accordingly.

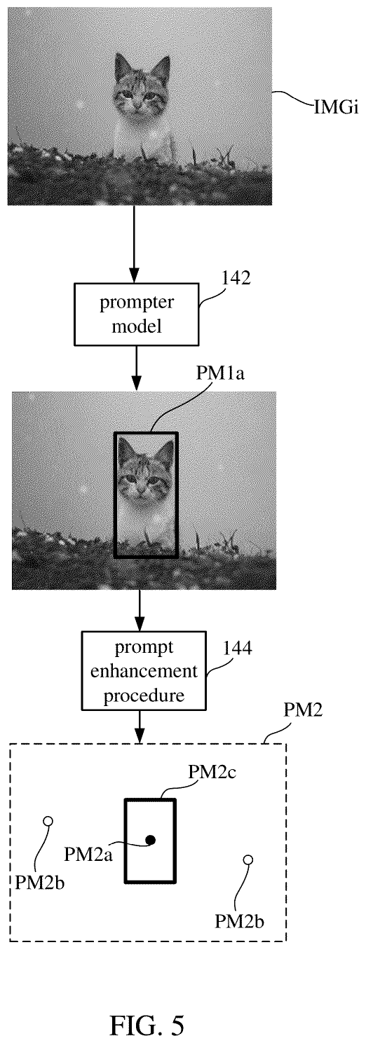

Reference is further made to FIG. 5, which is a schematic diagram illustrating a demonstrational case about the input image IMGi, the first prompt indicator PM1 and the second prompt indicator PM2 when the task type of the prompter model 142 is the object detection type in some embodiments.

In this case, the prompter model 142 is the object detection model trained with limited amount of cat-involving images, and the prompter model 142 is configured to mark a bounding box involving a cat on the input image IMGi. As shown in FIG. 5, in some embodiments, when the task type of the prompter model 142 is the object detection type, the first prompt indictor PM1 generated by the prompter model 142 includes a first bounding box PM1a, which corresponds an approximate location of an interested object (e.g., cat).

As shown in FIG. 5, the prompt enhancement procedure 144 is performed to the first prompt indictor PM1 (i.e., the first bounding box PM1a) for converting the first bounding box PM1a into a second bounding box PM2c.

In some embodiments, aforesaid converting can be (1) shifting a location of the first bounding box PM1a into the second bounding box PM2c, (2) enlarging a size of the first bounding box PM1a into the second bounding box PM2c, (3) trimming the size of the first bounding box PM1a into the second bounding box PM2c, or (4) duplicating the first bounding box PM1a as the second bounding box PM2c.

In embodiments shown in FIG. 5, the size of the first bounding box PM1a is trimmed to form the second bounding box PM2c of the second prompt indicator PM2. However, the disclosure is not limited thereto. The converting manner is determined according to characteristic of the segmentation foundation model 192.

As shown in FIG. 5, the prompt enhancement procedure 144 performed to the first prompt indictor PM1 further includes selecting a point within the second bounding box PM2c as a location of a positive click PM2a. In this case, a center point of the second bounding box PM2c is selected as the location of the positive click PM2a, which can be included in the second prompt indictor PM2.

As shown in FIG. 5, the prompt enhancement procedure 144 performed to the first prompt indictor PM1 further includes selecting one or more points outside the second bounding box PM2c as locations of negative clicks PM2b. In this case, random points away from the second bounding box PM2c can be selected as the locations of the negative clicks PM2b, which can be included in the second prompt indictor PM2.

In some embodiments, the second prompt indictor PM2 can be a combination of the positive click PM2a, the negative clicks PM2b and the second bounding box PM2c. All of the positive click PM2a, the negative clicks PM2b and the second bounding box PM2c together can be sent to the segmentation foundation model 192 as prompt inputs.

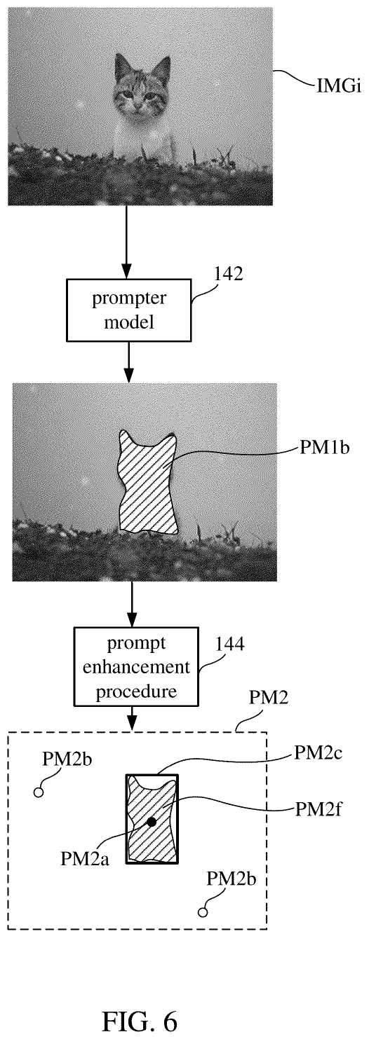

Reference is further made to FIG. 6, which is another schematic diagram illustrating a demonstrational case about the input image IMGi, the first prompt indicator PM1 and the second prompt indicator PM2 when the task type of the prompter model 142 is the image segmentation type in some embodiments.

In this case, the prompter model 142 is the image segmentation model trained with limited amount of cat-involving images, and the prompter model 142 is configured to generate a segmentation mask covering a cat on the input image IMGi. As shown in FIG. 6, in some embodiments, when the task type of the prompter model 142 is the image segmentation type, the first prompt indictor PM1 generated by the prompter model 142 includes a first segmentation mask PM1b, which covers approximate area of an interested object (e.g., cat).

As shown in FIG. 6, the prompt enhancement procedure 144 is performed to the first prompt indictor PM1 (i.e., the first segmentation mask PM1b) for modulating the first segmentation mask PM1b into the second segmentation mask PM2f.

In some embodiments, aforesaid modulating can be (1) shifting a location of the first segmentation mask PM1b into the second segmentation mask PM2f, (2) enlarging a size of the first segmentation mask PM1b into the second segmentation mask PM2f, (3) trimming the size of the first segmentation mask PM1b into the second segmentation mask PM2f or (4) duplicating the first segmentation mask PM1b as the second segmentation mask PM2f.

In embodiments shown in FIG. 6, the size of the first segmentation mask PM1b is trimmed to form the second segmentation mask PM2f of the second prompt indicator PM2. However, the disclosure is not limited thereto.

As shown in FIG. 6, the prompt enhancement procedure 144 performed to the first prompt indictor PM1 further includes obtaining a second bounding box PM2c according to boundary points of the first segmentation mask PM1b. In this case, top/bottom/rightmost/leftmost points of the first segmentation mask PM1b are configured to decide size and area of the second bounding box PM2c, which can be included in the second prompt indictor PM2.

As shown in FIG. 6, the prompt enhancement procedure 144 performed to the first prompt indictor PM1 further includes selecting a point within the second segmentation mask PM2f as a location of a positive click PM2a. In this case, a center point of the second segmentation mask PM2f is selected as the location of the positive click PM2a, which can be included in the second prompt indictor PM2.

As shown in FIG. 6, the prompt enhancement procedure 144 performed to the first prompt indictor PM1 further includes selecting one or more points outside the second segmentation mask PM2f as locations of negative clicks PM2b. In this case, random points away from the second segmentation mask PM2f can be selected as the locations of the negative clicks PM2b, which can be included in the second prompt indictor PM2.

In some embodiments, the second prompt indictor PM2 can be a combination of the positive click PM2a, the negative clicks PM2b, the second bounding box PM2c and the second segmentation mask PM2f as shown in FIG. 6. All of the positive click PM2a, the negative clicks PM2b, the second bounding box PM2c and the second segmentation mask PM2f together can be sent to the segmentation foundation model 192 as prompt inputs.

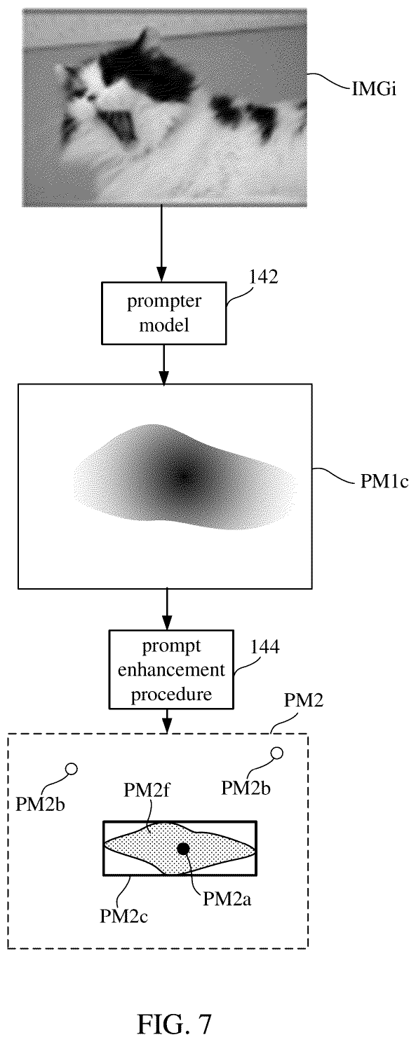

Reference is further made to FIG. 7, which is another schematic diagram illustrating a demonstrational case about the input image IMGi, the first prompt indicator PM1 and the second prompt indicator PM2 when the task type of the prompter model 142 is the classification type in some embodiments.

In this case, the prompter model 142 is the classification model trained with limited amount of cat-involving images, and the prompter model 142 is configured to generate a heat map PM1c. Value of feature points in the heat map PM1c will vary to indicate possibilities of the interest object (e.g., cat). For example, a feature point with a higher possibility overlapping with the cat can be darker (e.g., higher values), and a feature point with a lower possibility overlapping with the cat can be brighter (e.g., lower values), as shown in FIG. 7.

In embodiments as shown in FIG. 7, the prompt enhancement procedure performed to the first prompt indictor PM1 (e.g., the heat map PM1c) includes: (1) comparing values of feature points in the heat map PM1c with a threshold value; (2) locating first feature points exceeding the threshold value in the heat map PM1c, and locating second feature points below the threshold value in the heat map PM1c; (3) obtaining a second bounding box PM2c according to boundary points of the first feature points, or obtaining a second segmentation mask PM2f based on the first feature points. In this case, the second bounding box PM2c and/or the second segmentation mask PM2f can be integrated into a combination of the second prompt indictor PM2.

In embodiments shown in FIG. 7, an inner part (i.e., the first feature points exceeding the threshold value) of the heat map PM1c with higher possibilities forms the segmentation mask PM2f, and boundaries of the inner part form the bounding box PM2c.

As shown in FIG. 7, the prompt enhancement procedure 144 performed to the first prompt indictor PM1 further includes selecting a point from the first feature points exceeding the threshold value (corresponding to an area inside the second segmentation mask PM2f) as a location of a positive click PM2a. In this case, a center point of the second segmentation mask PM2f is selected as the location of the positive click PM2a, which can be included in the second prompt indictor PM2.

As shown in FIG. 7, the prompt enhancement procedure 144 performed to the first prompt indictor PM1 further includes selecting one or more points from the second feature points below the threshold value (corresponding to an area outside the second segmentation mask PM2f) as locations of negative clicks PM2b. In this case, random points away from the second segmentation mask PM2f can be selected as the locations of the negative clicks PM2b, which can be included in the second prompt indictor PM2.

In some embodiments, the second prompt indictor PM2 can be a combination of the positive click PM2a, the negative clicks PM2b, the second bounding box PM2c and the second segmentation mask PM2f as shown in FIG. 7. All of the positive click PM2a, the negative clicks PM2b, the second bounding box PM2c and the second segmentation mask PM2f together can be sent to the segmentation foundation model 192 as prompt inputs.

As shown in FIG. 3, the segmentation foundation model 192 includes an image encoder 192a, a prompt encoder 192b and a mask decoder 192c. The image encoder 192a is configured to receive the input image IMGi, and convert the input image IMGi into an input image embedding IMGe. The prompt encoder 192b is configured to receive the second prompt indictor PM2, and convert the second prompt indictor PM2 into a prompt vector PV. The mask decoder 192c is configured to generate the output segmentation mask SMK according to the input image embedding IMGe and the prompt vector PV generated by the prompt encoder 192b.

In some embodiments, the segmentation foundation model 192 can be implemented by the segment anything model (SAM). However, the disclosure is not limited thereto. The segmentation foundation model 192 can be implemented by a similar transformer-based foundation model, or a similar encoder-decoder-based foundation model.

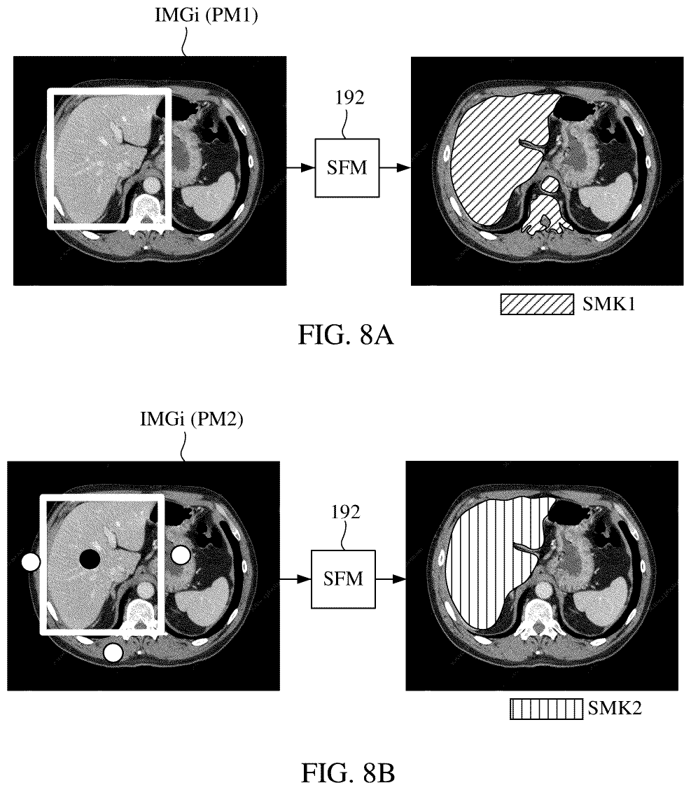

Reference is further made to FIG. 8A and FIG. 8B, which are schematic diagram illustrating different output segmentation masks generated by the segmentation foundation model 192 based on different prompt indictors according to some embodiments.

As shown in FIG. 8A, it is an example that the segmentation foundation model 192 receives the input image IMGi with the first prompt indictor PM1. In this case, the prompt input to the segmentation foundation model 192 is the first prompt indictor PM1 without performing the prompt enhancement procedure 144. As shown in FIG. 8A, the first prompt indictor PM1 only includes a bounding box. This bounding box marks an approximate location of a liver. However, the bounding box also covers some area around the liver. Based on the hint provided by the first prompt indictor PM1 (i.e., the bounding box), an output segmentation mask SMK1 generated by the segmentation foundation model 192 as shown in FIG. 8A may also other objects around the liver. In other words, the output segmentation mask SMK1 generated by the output segmentation mask SMK1 according to the first prompt indictor PM1 is not precise enough.

As shown in FIG. 8B, it is another example that the segmentation foundation model 192 receives the input image IMGi with the second prompt indictor PM2. In this case, the prompt input to the segmentation foundation model 192 is the second prompt indictor PM2 after performing the prompt enhancement procedure 144. As shown in FIG. 8B, the second prompt indictor PM2 includes a combination of a positive click, three negative clicks and a bounding box. This bounding box marks an approximate location of a liver. The positive click marks a target to be segmented (i.e. the liver). These negative clicks indicate what are not included in the segmentation target. Based on the hint provided by the second prompt indictor PM2, an output segmentation mask SMK2 generated by the segmentation foundation model 192 as shown in FIG. 8B can be more precise to crop out the target (i.e., liver) in this example.

As discussed in aforesaid embodiments, the image processing system 100 is able to perform image segmentation without training a large-scale model with a large of label data. The image processing system 100 can train a relatively small-scale prompter model 142. The image processing system 100 utilizes the prompter model 142 and the prompt enhancement procedure 144 to generate the second prompt indictor PM2, which is sent to the segmentation foundation model 192 for generating the output segmentation mask SMK. The segmentation foundation model 192 can be an external and pre-trained model. In general, the segmentation foundation model 192 has excellent versatility (i.e., capability of processing different images), the image processing system 100 integrated with the segmentation foundation model 192 can also process different types of images (e.g., medical images, traffic images, facial recognition images, fingerprint images).

In the framework of this disclosure, a small model with low computational complexity can even be selected as the prompter model 142, and the task of annotating data (for training this prompter model 142) can be simplified. In this case, the prompter model 142 can be trained by a limited amount of label data with simplified label categories. When there is a new task target to be added (e.g., an image segmentation about dog), the image processing system 100 is not required to train a large-scale model with dog-involving training data. The image processing system 100 can train the prompter model 142 with limited amounts of dog-involving label data. It can reduce a labeling cost (e.g., time and human resource) for training the prompter model 142. In the meantime, the final result (i.e., the output segmentation mask SMK) can be generated by the segmentation foundation model 192 with the proper prompt input (e.g., the second prompt indictor PM2), such that a preciseness of the output segmentation mask SMK can be maintained.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An image segmentation method, comprising:
providing an input image to a prompter model for generating a first prompt indictor according to a task type of the prompter model;
performing a prompt enhancement procedure, with reference to the task type of the prompter model, to the first prompt indictor for generating a second prompt indictor, wherein the prompt enhancement procedure comprising converting a location, a size or a prompt type of the first prompt indictor into the second prompt indictor with reference to the task type; and
providing the input image and the second prompt indictor to a segmentation foundation model for generating an output segmentation mask on the input image according to the second prompt indictor.

2. The image segmentation method of claim 1, wherein the task type of the prompter model comprises an object detection type, an image segmentation type or a classification type.

3. The image segmentation method of claim 1, wherein in response to that the task type of the prompter model is an object detection type, the first prompt indictor generated by the prompter model is a first bounding box,
wherein the prompt enhancement procedure performed to the first prompt indictor comprises: shifting a location of the first bounding box into a second bounding box, enlarging a size of the first bounding box into the second bounding box, or trimming the size of the first bounding box into the second bounding box,
wherein the second prompt indictor comprises the second bounding box.

4. The image segmentation method of claim 3, wherein in response to that the task type is the object detection type, wherein the prompt enhancement procedure performed to the first prompt indictor further comprises: selecting a first point within the second bounding box, or selecting a second point outside the second bounding box,
wherein the second prompt indictor further comprises a positive click at the first point or a negative click at the second point.

5. The image segmentation method of claim 1, wherein in response to that the task type is an image segmentation type, the first prompt indictor generated by the prompter model is a first segmentation mask,
wherein the prompt enhancement procedure performed to the first prompt indictor comprises: shifting a location of the first segmentation mask into a second segmentation mask, enlarging a size of the first segmentation mask into the second segmentation mask, trimming the size of the first segmentation mask into the second segmentation mask, or obtaining a bounding box according to boundary points of the first segmentation mask,
wherein the second prompt indictor comprises the second segmentation mask or the bounding box.

6. The image segmentation method of claim 5, wherein in response to that the task type is the image segmentation type, wherein the prompt enhancement procedure performed to the first prompt indictor further comprises: selecting a first point within the second segmentation mask, or selecting a second point outside the second segmentation mask,
wherein the second prompt indictor further comprises a positive click at the first point or a negative click at the second point.

7. The image segmentation method of claim 1, wherein in response to that the task type is a classification type, the first prompt indictor generated by the prompter model is a heat map,
wherein the prompt enhancement procedure performed to the first prompt indictor comprises:
comparing values of feature points in the heat map with a threshold value;
locating first feature points exceeding the threshold value in the heat map, and locating second feature points below the threshold value in the heat map; and
obtaining a bounding box according to boundary points of the first feature points, or obtaining a segmentation mask based on the first feature points, wherein the second prompt indictor comprises the bounding box or the segmentation mask.

8. The image segmentation method of claim 7, wherein in response to that the task type is the classification type, wherein the prompt enhancement procedure performed to the first prompt indictor further comprises: selecting a first point from the first feature points, or selecting a second point from the second feature points,
wherein the second prompt indictor further comprises a positive click at the first point or a negative click at the second point.

9. The image segmentation method of claim 1, further comprising:
generating an output image according to the output segmentation mask and the input image.

10. The image segmentation method of claim 1, wherein the prompter model is trained to achieve the task type based on a training dataset, the training dataset comprises training images and label data corresponding to the training images.

11. The image segmentation method of claim 10, wherein the prompter model is trained with a smaller scale and a specific type of datasets compared to a larger scale and diverse types of datasets utilized to train the segmentation foundation model.

12. The image segmentation method of claim 1, wherein the segmentation foundation model comprises:
an image encoder, configured to receive the input image, and convert the input image into an input image embedding;
a prompt encoder, configured to receive the second prompt indictor, and convert the second prompt indictor into a prompt vector; and
a mask decoder, configured to generate the output segmentation mask according to the input image embedding and the prompt vector.

13. An image processing system, comprising:
a storage unit, configured to store computer-executable instructions; and
a processing unit, coupled with the storage unit, the processing unit is configured to execute the computer-executable instructions, and the processing unit is configured to:
provide an input image to a prompter model for generating a first prompt indictor according to a task type of the prompter model;
perform a prompt enhancement procedure, with reference to the task type of the prompter model, to the first prompt indictor for generating a second prompt indictor, wherein the prompt enhancement procedure comprising converting a location, a size or a prompt type of the first prompt indictor into the second prompt indictor with reference to the task type; and
provide the input image and the second prompt indictor to a segmentation foundation model for generating an output segmentation mask on the input image according to the second prompt indictor.

14. The image processing system of claim 13, wherein in response to that the task type is an object detection type, the first prompt indictor generated by the prompter model is a first bounding box,
wherein the prompt enhancement procedure performed by the processing unit to the first prompt indictor comprises: shifting a location of the first bounding box into a second bounding box, enlarging a size of the first bounding box into the second bounding box, or trimming the size of the first bounding box into the second bounding box,
wherein the second prompt indictor comprises the second bounding box.

15. The image processing system of claim 14, wherein in response to that the task type is the object detection type, wherein the prompt enhancement procedure performed by the processing unit to the first prompt indictor further comprises: selecting a first point within the second bounding box, or selecting a second point outside the second bounding box,
wherein the second prompt indictor further comprises a positive click at the first point or a negative click at the second point.

16. The image processing system of claim 13, wherein in response to that the task type is an image segmentation type, the first prompt indictor generated by the prompter model is a first segmentation mask,
wherein the prompt enhancement procedure performed by the processing unit to the first prompt indictor comprises: shifting a location of the first segmentation mask into a second segmentation mask, enlarging a size of the first segmentation mask into the second segmentation mask, trimming the size of the first segmentation mask into the second segmentation mask, or obtaining a bounding box according to boundary points of the first segmentation mask,
wherein the second prompt indictor comprises the second segmentation mask or the bounding box.

17. The image processing system of claim 16, wherein in response to that the task type is the image segmentation type, wherein the prompt enhancement procedure performed by the processing unit to the first prompt indictor further comprises: selecting a first point within the second segmentation mask, or selecting a second point outside the second segmentation mask,
wherein the second prompt indictor further comprises a positive click at the first point or a negative click at the second point.

18. The image processing system of claim 13, wherein in response to that the task type is a classification type, the first prompt indictor generated by the prompter model is a heat map,
wherein the prompt enhancement procedure performed by the processing unit to the first prompt indictor comprises:
comparing values of feature points in the heat map with a threshold value;
locating first feature points exceeding the threshold value in the heat map, and locating second feature points below the threshold value in the heat map; and
obtaining a bounding box according to boundary points of the first feature points, or obtaining a segmentation mask based on the first feature points, wherein the second prompt indictor comprises the bounding box or the segmentation mask.

19. The image processing system of claim 18, wherein in response to that the task type is the classification type, wherein the prompt enhancement procedure performed by the processing unit to the first prompt indictor further comprises: selecting a first point from the first feature points, or selecting a second point from the second feature points,
wherein the second prompt indictor further comprises a positive click at the first point or a negative click at the second point.

20. The image processing system of claim 13, wherein the processing unit is configured to generate an output image according to the output segmentation mask and the input image.
